(19) United States
(12) Patent Application Publication
(10) Pub. No.: US 2018/0354078 A1
(43) Pub. Date: Dec. 13, 2018

(54) REINFORCING STRUCTURAL COMPONENTS

(71) Applicant: AUTOTECH ENGINEERING A.I.E., Amorebieta-Etxano (ES)

(72) Inventors: Elisenda VILA I FERRER, Sant Quirze Del Valles (ES); Laura GALCERAN OMS, Canet De Mar (ES)

(21) Appl. No.: 15/780,154

(22) PCT Filed: Dec. 16, 2016
(86) PCT No.: PCT/EP2016/081530

§ 371 Date: May 30, 2018

(30) Foreign Application Priority Data
Dec. 18, 2015 (EP) 15382642.5

(51) Int. Cl. B23K 26/70; B23K 26/361; B23K 26/34; B23K 26/144; B23K 26/14; B23K 26/067; B23K 26/06; B23K 26/03

(52) U.S. Cl. CPC B23K 26/703; B23K 26/361; B23K 26/34; B23K 26/144; B23K 2101/185; B23K 26/0676; B23K 26/0608; B23K 26/032; B23K 26/1464

(57) ABSTRACT

Methods and tools for manufacturing reinforced structural components are described. The methods comprise providing a structural component having a steel substrate and a metal coating layer. The method further comprises selecting a reinforcement zone of the structural component, guiding a first laser beam to ablate at least a part of the coating layer of the reinforcement zone, locally depositing a reinforcement material on the ablated reinforcement zone to create a local reinforcement on a first side of the structural component, wherein locally depositing a material on the reinforcement zone comprises supplying a reinforcement material to the ablated reinforcement zone, and substantially simultaneously applying laser heating using a second laser beam to melt the reinforcement material and part of the steel substrate of the ablated reinforcement zone to mix the melted reinforcement material with the melted part of the steel substrate. The disclosure further relates to reinforced components obtained using such methods.

### This application claims the benefit of European Patent Application EP15382642.5 filed on Dec. 18, 2015.

The present disclosure relates to methods for manufacturing reinforced structural components and to the structural components obtained through these methods.

### BACKGROUND

The demand for weight reduction in e.g. the automotive industry has led to the development and implementation of lightweight materials, manufacturing processes and tools. The growing concern for occupant safety also has led to the adoption of materials which improve the integrity of the vehicle during a crash while also improving the energy absorption. In that sense, vehicle parts made of high-strength and ultra-high-strength steel (UHSS) are often employed in order to satisfy criteria for lightweight construction.

Typical vehicle components that need to meet weight goals and safety requirements include structural and/or safety elements such as door beams, bumper beams, cross/side members, A/B pillar reinforcements, and waist rail reinforcements.

For example, a process known as Hot Forming Die Quenching (HFDQ) uses boron steel sheets to create stamped components with Ultra High Strength Steel (UHSS) properties, with tensile strengths of at least 1000 MPa, preferably approximately 1500 MPa or up to 2000 MPa or more. The increase in strength allows for a thinner gauge material to be used, which results in a weight savings over conventionally cold stamped mild steel components.

Simulations performed during the design phase of a typical vehicle component can identify points or zones of the formed component that need reinforcement (because lighter and thinner metal sheets and blanks are used) in order to increase strength and/or stiffness. Alternatively a redesign may be done in order to steer deformations.

In that sense, there are several procedures with which some areas of a component can be reinforced or softened in order to redistribute stress and save weight by reducing the thickness of the component. These known procedures for reinforcing a component are, for example, procedures adding welded reinforcements prior to any forming process. Such reinforcements may be “patchworks” in which partial or complete overlapping of several blanks may be used, or blanks or plates of different thickness that may be welded “edge to edge”, i.e. Tailor welded blanks (TWB). Structural mechanical requirements can thus be achieved theoretically with a minimum of material and thickness (weight).

In some of these methods however, further manufacturing processes are involved. For example, when ultra-high strength steels (e.g. Usibor 1500P) are being hot formed some weldability problems may arise due to an aluminum-silicon (AlSi) coating usually used to protect from corrosion and oxidation damage. In order to overcome these problems it is known to remove a part of the coating in an area close to the welding gap by laser ablation. However, this represents an additional step in the manufacturing process of a vehicle component.

Furthermore, when welded reinforcements (patchworks) are added to a blank, partial or complete overlapping of blanks occur. These areas are potential corrosion starting points as overlapped regions remain underneath and do not receive e.g. a corrosion coating.

In addition, depending on the component being formed there may be regions in which it is not possible or it is at least cumbersome to use welded reinforcements e.g. corners or areas with elevation changes. Patchworks are normally welded using a spot welding which requires a minimum space to distribute the spots. Additionally, patchworks need a minimum size in order to be easily welded. This may involve an extra weight as the reinforcement needs to have a minimum size in order to be welded rather than having the right size (minimum) needed to reinforce the required area.

Document EP2907603 describes a method for producing a locally reinforced sheet metal having at least a local metallic reinforcement provided in at least one of the sides.

The aforementioned problems and/or challenges are not unique to the automotive industry or to the materials and processes used in that industry. Instead these challenges may be encountered in any industry wherein weight reduction is an objective. When weight reduction is an objective, the components become ever thinner which can thus lead to an increased need for reinforcements.

It is an object of the present disclosure to provide improved methods of manufacturing reinforced structural components.

### SUMMARY

It is proposed to combine laser ablation of the coating layer of a steel component using a first laser beam with depositing a reinforcement material on the ablated surface of the steel component using a second laser beam to melt and mix the reinforcement material with part of the steel component. This allows for better adherence and dilution of the reinforcement material on the ablated surface. For the purposes of this disclosure the term “ablation” is used to denote the at least partial elimination of a coating layer.

In a first aspect, a method for manufacturing reinforced steel structural components is provided. The method comprises providing a previously formed structural component having a steel substrate and a metal coating layer. The method further comprises selecting a reinforcement zone of the previously formed steel structural component, selecting a first direction in the reinforcement zone, guiding a first laser beam along the first direction to ablate at least a part of the coating layer of the reinforcement zone and locally depositing a reinforcement material on the ablated reinforcement zone to create a local reinforcement on a first side of the structural component.

Locally depositing a material on the reinforcement zone comprises supplying a reinforcement material to the ablated reinforcement zone, and substantially simultaneously applying laser heating along the first direction using a second laser beam to melt the reinforcement material and part of the steel substrate of the ablated reinforcement zone to mix the melted reinforcement material with the melted part of the steel substrate.

According to this aspect, a local reinforcement process is carried out in a previously formed steel component to create e.g. ribs or reinforcements on the component. The removal of at least a part of the coating layer before the material is deposited allows for better dilution or melting of the reinforcement (or metal filler) material deposited on the steel substrate of the ablated reinforcement zone. Thus the reinforcement material mixes and dilutes better with the steel substrate of the reinforcement zone which results in uniform reinforcement in the reinforcement zone. The ribs or reinforcements created can provide stiffness in specific areas (points or zones needing reinforcement) of the component. This way, the zones that need reinforcement can be better strengthened and/or deformations can be better redirected. Furthermore, as the reinforcement material is melted in the ablated zone, the melted material fills all of the ablated area and no gaps remain at the border of the reinforcement area. Thereby local corrosion of the ablated steel substrate may be avoided. The time between the ablation and locally depositing a material on the ablated reinforcement zone should preferably be shortened. Preferably, the laser beams are moved in unison, so that the first laser beam may ablate at least a part of the coating layer of the reinforcement zone and the second laser beam may heat the reinforcement zone shortly after the coating has been ablated. Corrosion of the ablated area is thus reduced or may be completely avoided. By using localized reinforcement, the volume and thickness of the final component may be optimized thus reducing its weight. Using this method, widely varying reinforcements may be “written” or drawn” onto an already formed blank.

The use of laser heat with reinforcement (metal filler) material may allow the formation of very specific and precise geometries, i.e. reinforcements can be tailor-made, having a wide variety of shapes or designs such as circles around holes, straight lines intersecting each other to form a grid, intermittent or broken lines and large or small figures among others. Mechanical properties of the reinforcements created may thus depend on the geometry drawn with the metal filler material and the laser heating process along the selected direction and on the previously ablated reinforcement zone.

The method is thus quite versatile and substantially any desired geometry can be achieved. Complicated geometries such as corners or areas with elevation changes may also be reinforced. Localized strength enhancement may thus be achieved i.e. reinforcement having specific and precise geometries which may optimize (reduce) the weight of the final reinforced component. Inventors have found that the use of cladding for creating local reinforcement in a formed component leads to particularly good results in formed components having a thickness of approximately 0.7 mm to approximately 5 mm.

In some examples the first laser beam may comprise a single spot laser beam. This may allow reinforced zones that are relatively comparable in size with the size of the spot of the first laser beam. It may be used in areas, e.g. around screw holes where a local reinforcement is required to account for a structural interruption or discontinuity.

In some examples the first laser beam may comprise a twin spot laser beam. The two spots may be arranged substantially perpendicularly to the first direction. This configuration may be used when ablation is required in a reinforcement zone wider than the size of the spot of a single laser beam. Thus the ablation area may substantially extend between the outer edges of the two laser beam spots. The two laser beam spots may be arranged side-by-side at a certain distance to allow the effect of heating in the area between them to ablate the coating.

In some examples, the two spots of the first laser beam may be distributed evenly in the reinforcement zone, i.e. homogenously or uniformly distributed in the reinforcement zone. Placing the spots too close could cause overheating in the intermediate area while spacing them too much apart may leave some area of the reinforcement zone unablated. Thus, the two spots of the first laser beam may be distributed in the reinforcement zone to completely ablate the reinforcement zone while no area is overly heated. The desired reinforcement area may, in some examples, be a pair of tracks. In that case the first spot may ablate the first track while the other spot the second track.

In some examples, the second laser beam may comprise a twin spot laser beam. In some examples, such two spots may be arranged substantially perpendicular to the first direction. Alternatively, such two spots may be arranged substantially parallel to the first direction.

In some examples, the reinforcement (metal filler) material may comprise a metal powder provided in a powder gas flow or a solid metal provided as a metal wire. The reinforcement material, either in its powder or wire form, may be stainless steel AlSi 316 L, as commercially available from e.g. Hoganas. The powder may have the following composition in weight percentages: 0% -0.03% carbon, 2.0-3.0% of molybdenum, 10%-14% of nickel, 1.0-2.0% of manganese, 16-18% chromium, 0.0-1.0% of silicon, and the rest iron and impurities. Alternatively 431 L HO, as commercially available from e.g. Hoganäs® may be used. This powder has the following composition in weight percentages: 70-80% of iron, 10-20% of chromium, 1.0-9.99% of nickel, 1-10% of silicon, 1-10% of manganese and the rest impurities. It may be also possible to combine these reinforcement materials. For example, a reinforcement material comprising 35% in weight of AISI 316 L and 65% in weight of 431 L HO exhibits good ductility and strength.

Further examples may use 3533-10, as further commercially available from e.g. Hoganäs®. The powder has the following composition in weight percentages: 2.1% carbon, 1.2% of silicon, 28% of chromium, 11.5% of nickel, 5.5% of molybdenum, 1% of manganese and the rest iron and impurities.

It was found that the presence of nickel in these compositions led to good corrosion resistance and promoted the austenite formation. The addition of chromium and silicon aids in corrosion resistance, and molybdenum aids in increasing the hardness. In alternative examples other stainless steels may also be used, even UHSS. In some examples, the powder may incorporate any component providing different (e.g. higher) mechanical characteristics depending on circumstances. The above mentioned reinforcement materials may be easy to melt, dilute and mix with the part of the steel substrate of the ablated zone using the second laser beam.

In some examples the method may further comprise drawing specific geometric shapes on the first side of the structural component with the metal filler material and the laser heating. The reinforcement zone may therefore correspond to the shape to be drawn and a path may be selected along the corresponding reinforcement zone. The first direction may then correspond to a direction along the selected path. The reinforcement zone of the component and/or the specific geometric shapes may be previously defined from crash simulations of the components. This way the specific geometric shapes may be created as a function of the deformation energy involved in the crash. In some examples, the thickness of the reinforcement zone or the specific geometric shapes may further depend on the thickness of the blank used to form the component. In further examples, the reinforcement zone may be defined to compensate a loss of strength caused by holes needed e.g. for screws. In these cases the reinforcement zone may surround the holes provided in the component. In more examples, the reinforcement zone may be defined at those areas in which a hinge or a hook (e.g. tow hook of a bumper) is provided.

In some examples, the method may further comprise providing cooling to areas on a second side of the structural component that is opposite to the first side. Such cooling may take place as the reinforcement material is being deposited or after the reinforcement material has been deposited in the selected reinforcement zone. The provision of cooling to areas on an opposite side of the structural component guarantees that the heated-affected areas also achieve a cooling rate that is high enough to substantially obtain a martensite microstructure or at least substantially reduces the formation of ferrite matrix microstructures in the final reinforced component. Also, the provision of cooling can reduce the heat affected areas in that the areas do not reach high temperatures which can negatively affect the microstructure.

In some examples the metal coating layer may be a layer of aluminum or of an aluminum alloy or a layer of zinc or of a zinc alloy.

In some examples the steel substrate may comprise boron steel. An example of boron steel used in the automotive industry is 22MnB5 steel. The composition of 22MnB5 is summarized below in weight percentages (rest is iron (Fe) and impurities):

| C | Si | Mn | P | S |
|---|---|---|---|---|
| 0.20-0.25 | 0.15-0.35 | 1.10-1.35 | <0.025 | <0.008 |

| Cr | Ti | B | N |
|---|---|---|---|
| 0.15-0.30 | 0.02-0.05 | 0.002-0.004 | <0.009 |

Several 22MnB5 steels are commercially available having a similar chemical composition. However, the exact amount of each of the components of a 22MnB5 steel may vary slightly from one manufacturer to another. Usibor® 1500P is one example of a commercially available 22MnB5 steel manufactured by Arcelor. The composition of Usibor® is summarized below in weight percentages (rest is iron (Fe) and impurities):

| C | Si | Mn | P | S | Cr | Ti | B | N |
|---|---|---|---|---|---|---|---|---|
| 0.24 | 0.27 | 1.14 | 0.015 | 0.001 | 0.17 | 0.036 | 0.003 | 0.004 |

In other examples the 22MnB5 may contain approximately 0.23% C, 0.22% Si, and 0.16% Cr. The material may further comprise Mn, Al, Ti, B, N, Ni in different proportions.

Various other steel compositions of UHSS may also be used in the automotive industry. Particularly, the steel compositions described in EP 2 735 620 A1 may be considered suitable. Specific reference may be had to table 1 and paragraphs 0016-0021 of EP 2 735 620, and to the considerations of paragraphs 0067-0079. In some examples the UHSS may contain approximately 0.22% 0,1.2% Si, and 2.2% Mn.

Steel of any of these compositions (both 22MnB5 steel such as e.g. Usibor® and the other compositions mentioned or referred to before) may be supplied with a coating in order to prevent corrosion and oxidation damage. This coating may be e.g. an aluminum-silicon (AlSi) coating or a coating mainly comprising zinc or a zinc alloy.

Patchwork blanks and tailored blanks may also be used or useful in other industries.

Usibor® 1500P is supplied in ferritic-perlitic phase. It is a fine grain structure distributed in a homogenous pattern. The mechanical properties are related to this structure. After heating, a hot stamping process, and subsequent quenching, a martensite microstructure is created. As a result, maximal strength and yield strength increase noticeably. Similar processes may be applicable to any other steel composition.

In some examples, the previously formed structural component may be obtained by hot forming die quenching.

In another aspect, a tool for reinforcing previously formed steel structural components is disclosed. The tool may comprise an imaging device to select one or more reinforcement zones of a previously formed structural component having a metal coating. The tool may further comprise one or more laser heads. The one or more laser heads may comprise a laser beam source to generate a first laser beam and a second laser beam. In some examples, the laser beam source may comprise a first laser beam source to generate the first laser beam and a second laser beam source to generate the second laser beam. The one or more laser heads may be configured to direct the spot of the second laser beam on the structural component at a distance of between 2 mm and 50 mm from the spot or the spots of the first laser beam. The tool may further comprise a reinforcement (metal filler) material depositor. Furthermore, the tool may comprise a controller, coupled to the imaging device, the one or more laser heads and the reinforcement material depositor. The controller may be configured to select a first direction based on data received from the imaging device, guide the first laser beam along the first direction to ablate at least a part of the coating layer of the reinforcement zone, instruct the reinforcement material depositor to locally deposit reinforcement material on the ablated reinforcement zone, and guide the second laser beam along the first direction to apply laser heating to melt the reinforcement material on the ablated zone. The distance between the spots of the two laser beams may depend on various factors. For example, the ablated coating may need to be removed before the deposition takes place. Therefore the distance may be such that the deposited material may not be accidentally removed as part of the ablated material removal. In other words, any removal of coating from the ablated zone needs to be completed or take place sufficiently far away before deposition of reinforcement material takes place in the ablated area. Furthermore, any deposition of the reinforcement material preferably is made sufficiently close after the removal of the coating from the ablated zone, in order to reduce or avoid the corrosion of the ablated area. The first and second laser beams may thus preferably be guided in unison. One way to remove the ablated material may be with an air blowing system. However, if no further removal needs to take place (for example because the ablation process pushes the ablated coating off the reinforcement zone) then the distance between the two spots may be relatively close.

In some examples the first and second laser sources may be comprised in a single laser head. This allows for the two laser beams to be precisely aligned during the entire ablation and melting process which, in turn allows for a higher speed of reinforcement. Since the first and second laser sources might be comprised in a single laser head, both lasers can be moved in unison, i.e. moved following the same track. Alternatively, the two laser beams in the single laser head may originate from a single laser source, i.e. a single laser head may generate the first and the second laser beam

In some examples, the first laser source may be comprised in a first laser head and the second laser source in a second laser head. The first and second laser heads may be arranged to be moveable in unison. Using two laser heads allows for separate control of movement characteristics of the spots. For example, the laser head responsible for the ablation spot (or spots in case of twin-spot beam) may displace the spot in a second direction while the head moves in the first direction to e.g. perform sweeping of the ablated area to remove any residues of the ablation. The second head would then only provide the movement of the second laser beam along the first direction.

In yet another aspect, a product is disclosed as obtainable by a method according to previous aspects disclosed herein. The resulting product may demonstrate improved characteristics as the reinforcement material may be homogeneously dissolved on and adhere to the ablated area as the ablated area is already preheated from the ablation laser and the two processes (ablation and material deposition) are not separated in time and space but are performed successively before the ablated area is allowed to cool down.

In some examples, the local reinforcement achieved for the obtained product may have a minimum thickness of 0.2 mm. The minimum thickness ensures the provision of increased mechanical strength of the component in the reinforcement zone. In an example, the thickness of the reinforcement (i.e. the increase of the thickness with respect to the component) may be from 0.2 to 10 mm in particular from 0.2 to 6 mm, and more particularly from 0.2 to 2 mm.

Examples of the present disclosure may be used in components that have been formed in a variety of ways, including e.g. hot stamping, roll forming, and hydroforming. Examples of the present disclosure may be used in components of different materials, and in particular different steels.

### BRIEF DESCRIPTION OF THE DRAWINGS

Non-limiting examples of the present disclosure will be described in the following with reference to the appended drawings, in which:

FIG. 1 shows an example of manufacturing a reinforced steel structural component.

FIG. 2 shows an example reinforced steel structural component;

FIG. 3 is a top view of a reinforcement operation according to an example;

FIG. 4 shows a tool for reinforcing a reinforcement zone 12 of a previously formed steel structural component according to an example;

FIGS. 5a-5d show examples of different specific reinforcement geometries that may be obtained by a method substantially as hereinbefore described;

FIGS. 6 and 7 each shows an example of a reinforced component manufactured by any method substantially as hereinbefore described;

FIG. 8 is a flow diagram of a method of manufacturing reinforced steel structural components according to an example.

### DETAILED DESCRIPTION OF EXAMPLES

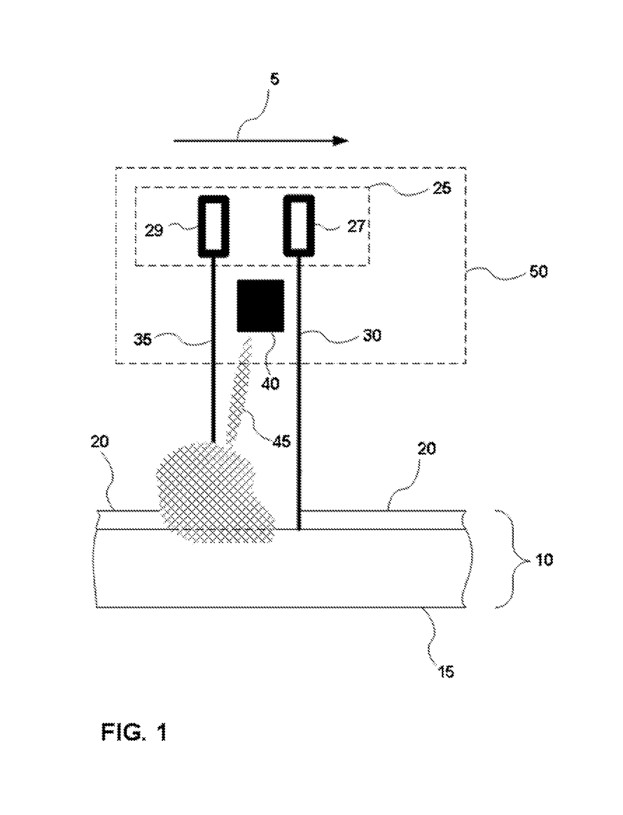

FIG. 1 shows an example of manufacturing a reinforced steel structural component. A previously formed steel structural component 10 may comprise a steel substrate 15 and a coating layer 15 (e.g. of aluminum or of an aluminum alloy or of zinc or of a zinc alloy). A laser head 25 may comprise a first laser source 27 and a second laser source 29. The first laser source 27 may generate a first laser beam 30 that may be used to ablate a portion of the coating layer 20. The first laser beam 30 may be guided by the first laser source 27 that may be an individual laser head or may form part of a laser head that may be shared between the first laser source 27 and the second laser source 29. The first laser source 27 may be a pulsed laser, e.g. a Q-switched laser having a nominal energy of 450 W delivering a 70 nsec pulse with a pulse energy of 42 mJ.

The laser head 25 may be relatively displaced in a first direction 5 with respect to the previously formed steel structural component 10 so as the first laser beam 30 to be applied to the coating layer 20. The first direction 5 may be a direction along a path that may require reinforcement. Therefore, ablation may take place only in a selected reinforcement zone of the previously formed steel structural component 10 where reinforcement may be required. A material depositor 40 may then be used to locally deposit a material 45 on the ablated reinforcement zone to create a local reinforcement on the structural component.

The material depositor 40 may provide reinforcing material 45 e.g. in the form of a solid wire or in the form of powder. The reinforcing material may be heated and melted in the ablated reinforcement zone with the use of the second laser beam 35 generated by the second laser source 29. The material depositor 40 may be moveable in unison with the laser head 25.

The material depositor 40 may be part of a single reinforcement applier 50 that may include the material depositor 40 and the laser head 25 or it may be separate but synchronised with the laser head configuration 25 so that they are moveable in tandem. The material depositor 40 may be a gas powder nozzle providing a gas powder flow. The gas powder nozzle may be coaxially arranged with the second laser source 29 so that the gas powder flow and the laser beam may be substantially perpendicular to a surface of the component on which the reinforcement is to be formed. The gas powder flow may thus be fed to the reinforcement zone while the second laser beam is being applied. In alternative examples, the gas powder flow may be fed at an angle with respect to the component. In some of these examples, the gas powder flow may also be fed at an angle with respect to the laser beam or it may be coaxially arranged with respect to the laser beam as in the previous example. Alternatively, a solid wire may be used to provide the reinforcement material.

As the reinforcement operation progresses along the first direction the reinforcement material that has been heated and melted in the reinforcement zone may begin to cool down and solidify on the ablated reinforcement zone. The solidified reinforcement material may thus cover all the area that was ablated thus minimising corrosion zones in unprotected border areas.

The power of the first laser source should be enough to melt at least the coating layer of the previously formed component having a typical thickness i.e. in the range of 0.7-5 mm.

The second laser source may have a power sufficient to melt at least the reinforcement material (powder or wire) throughout the entire zone on which the reinforcement is to be formed.

In some examples, melting may comprise melting using a laser having a power of between 2 kW and 16 kW, optionally between 2 and 10 kW.

By increasing the power of the lasers the overall velocity of the process may be increased.

Optionally, a Nd-YAG (Neodymium-doped yttrium aluminum garnet) laser may be used. These lasers are commercially available, and constitute a proven technology. This type of laser may also have sufficient power to melt an outer surface (coating layer) of a formed component and allows varying the width of the focal point of the laser and thus of the reinforcement zone. Reducing the size of the “spot” increases the energy density, whereas increasing the size of the spot enables speeding up the ablation process. The spot may be very effectively controlled and various types of ablation are possible with this type of laser. This type of laser may also have sufficient power to melt the reinforcement material on the ablated zone. However, the power required for ablating the coating layer may be different from the power required for melting the reinforcement material. Thus, two such lasers may be necessary or a dual-source laser with varying power per spot.

In alternative examples, a CO₂ laser with sufficient power or a diode laser may be used.

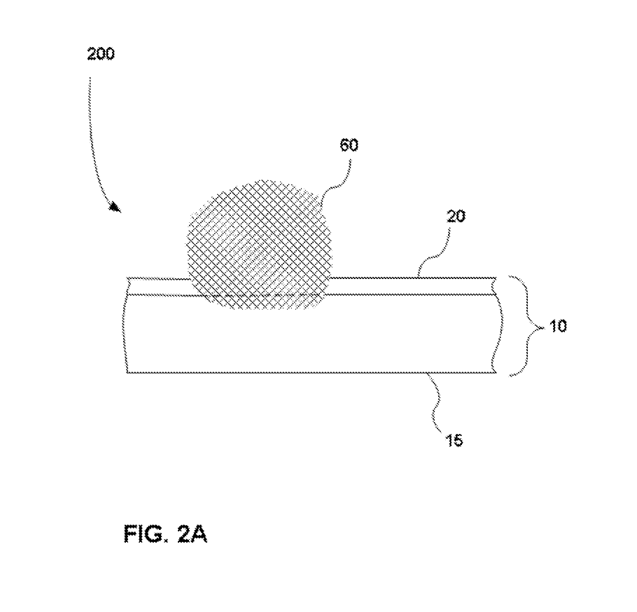

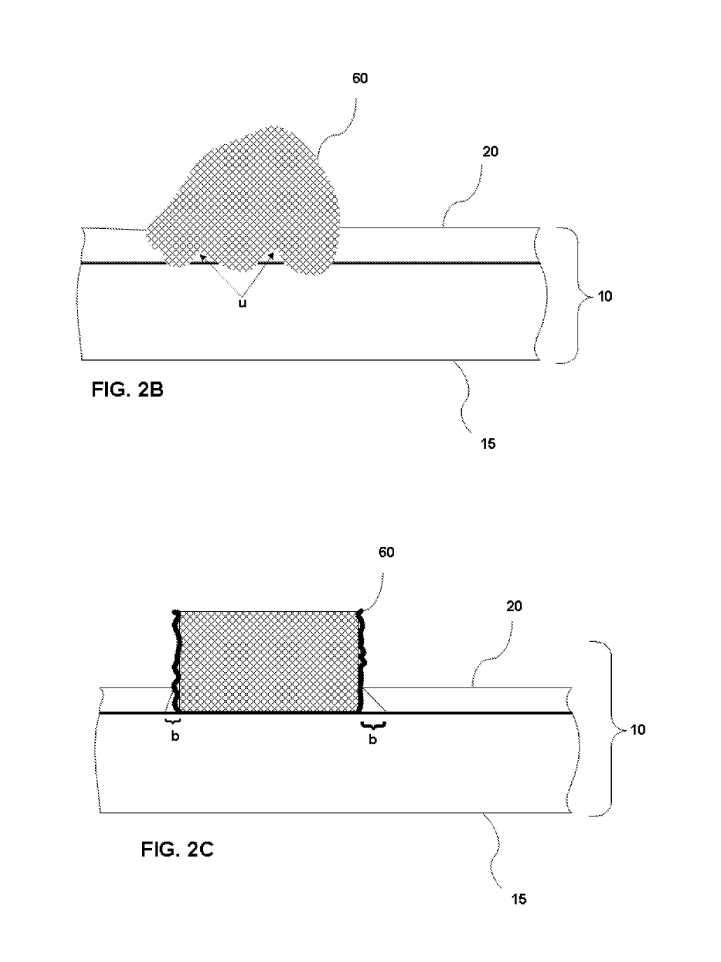

FIG. 2A shows an example of a reinforced steel structural component manufactured according to the process discussed with reference to FIG. 1. The reinforced component 200 may comprise a steel substrate 15, a coating layer 20 and reinforcement 60. The reinforcement 60 may be substantially deposited in an ablated area of the coating layer 20, melted and mixed with a portion of the steel substrate 15. As shown in FIG. 2, the reinforcement may adhere and dilute directly with the steel substrate in the ablated coating layer zone and partially to the side of the coating layer 20 leaving substantially no ablated steel substrate area uncovered. The benefits of a component or product reinforced using the above process shall be explained when compared with two alternative reinforcement processes discuss hereinafter with reference to FIG. 2B and FIG. 2C.

FIG. 2B shows a reinforced steel structural component where reinforcement material was added without prior ablation of the coating layer. The steel component 10 may have a steel substrate 15 and a coating layer 20 in a similar manner as the component discussed with reference to FIG. 1. A reinforcement material 60 in the form of powder or wire may be deposited with laser heating on the steel component 10 and effectively on the coating layer. Although the reinforcement as provided with this process may be sufficient in circumstances, as it is shown in FIG. 2B, at least part (indicated with the letter u) of the reinforcement material 60 may not be diluted and mixed with the steel substrate 15 when heated but remains or gets diluted partly within the coating layer. This may result in non-homogeneous and therefore poorer performance of the reinforced steel structural component 10 at the affected areas when compared with the reinforced steel structural component discussed with reference to FIG. 2A.

FIG. 2C shows a reinforced steel structural component where a part of the coating layer has been first laser ablated and where subsequently a stainless steel component was attached in the ablated area. As the size of the steel component may not correspond 100% with the size of the ablated area, the border areas (indicated with the letter b) of the ablated areas of the steel substrate may be prone to corrosion as the steel substrate is not stainless, i.e. the coating layer 20 was providing protection from oxidisation. Such a situation may be avoided with the product discussed with ref. to FIG. 2A, as the deposited reinforcement material when melted may flow and cover all the ablated area and leave no border areas uncovered and prone to oxidisation or corrosion.

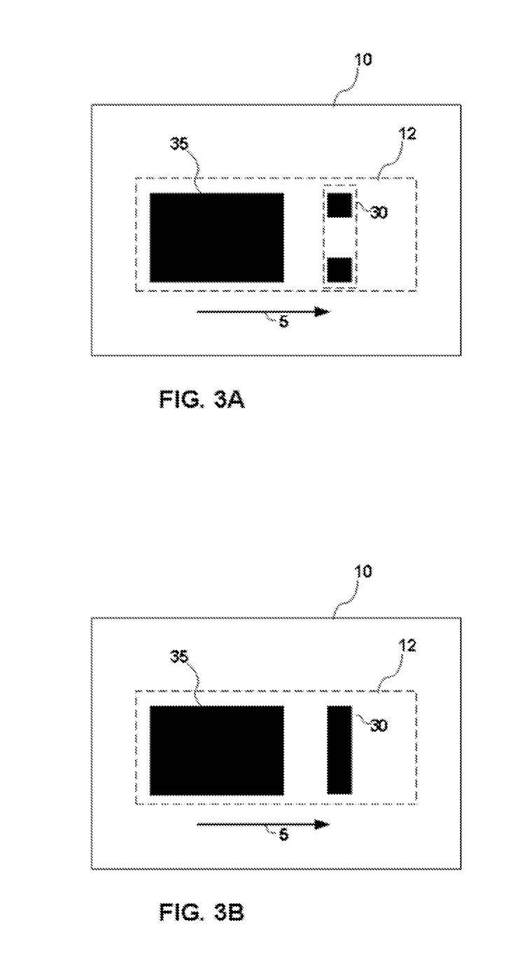

FIG. 3A is a top view of a reinforcement operation according to an example. A reinforcement zone 12 is selected on a previously formed steel structural component 10 having a coating layer. A first laser beam 30 comprises a twin-spot laser beam may be moveable along the first direction 5. The twin-spot laser beam may ablate the reinforcement zone 12 along the operation path. A second laser beam 35 may then heat and fuse a reinforcing material (not shown) deposited in the ablated zone. Depending on the reinforcement zone, the laser beam may provide a single oval or rectangular spot or a twin-spot. The size of the spot may be such as to cover at least the area of the reinforcement zone where dilution of the reinforcement material is desired. FIG. 3B is a top view of an example reinforcement operation using a first laser beam 30 with a single rectangular spot for ablation. As shown in FIG. 3A and 3B the size of the spot of the first laser beam may be substantially smaller than the size of the small of the second laser beam. Accordingly, the power of the first laser source may be substantially lower than the power of the second laser source. The power of the first laser source may be around 450 W while the power of the second laser source may be between 2 kW and 16 kW, optionally between 2 kW and 10 kW.

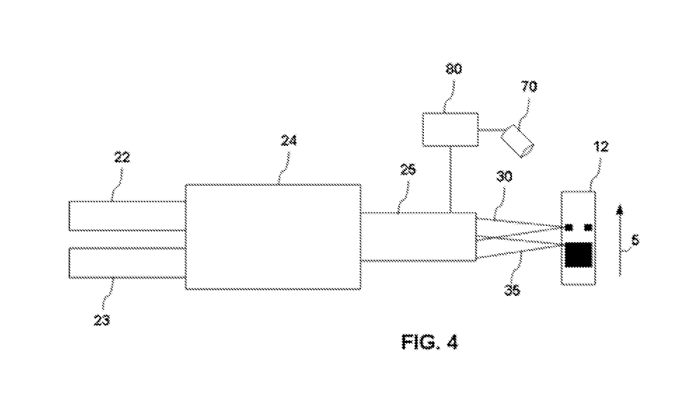

FIG. 4 shows a tool for reinforcing a reinforcement zone 12 of a previously formed steel structural component according to an example. A first optical fiber may provide a first optical signal to beam shaper 24 and a second optical fiber may provide a second optical signal to beam shaper 24. The beam shaper 24 may then provide the optical signals to the laser head configuration 25. The laser head configuration 25 may generate the first laser beam 30 to be used for ablation of the coating layer of the reinforcement zone 12. The laser head configuration 25 may also generate the second laser beam 35 to be used for heating and melting the reinforcement material (not shown) on the ablated reinforcement zone. The tool may be moveable along the first direction 5. Thus, a reinforced steel structural component may be generated along a path of a selected reinforcement zone. An imaging device 70, e.g. a camera, may be used to select the reinforcement zone. A controller 80 may be coupled to the imaging device and to the laser head configuration 25 to receive the information from the imaging device and guide the laser beams on the selected reinforcement zone.

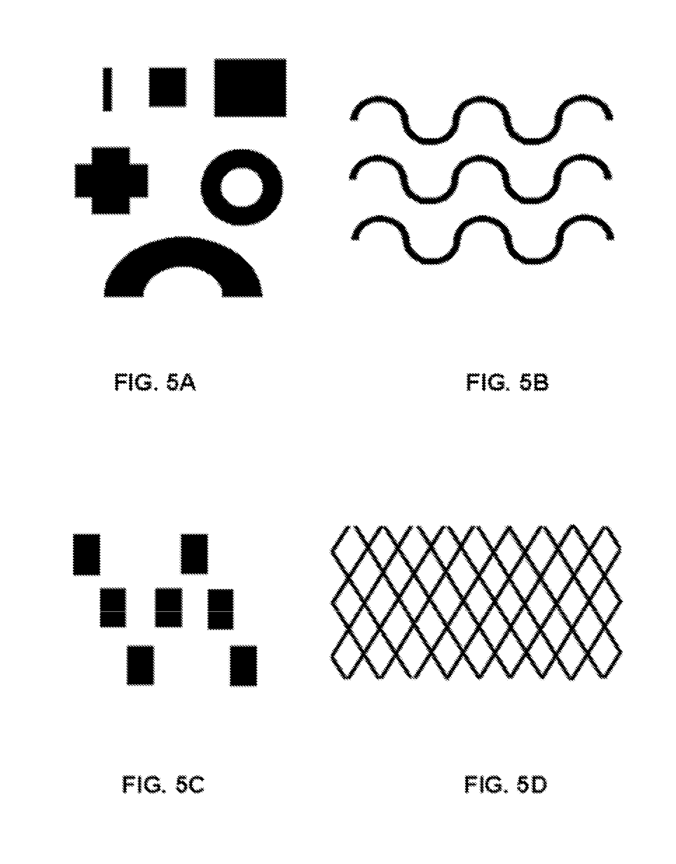

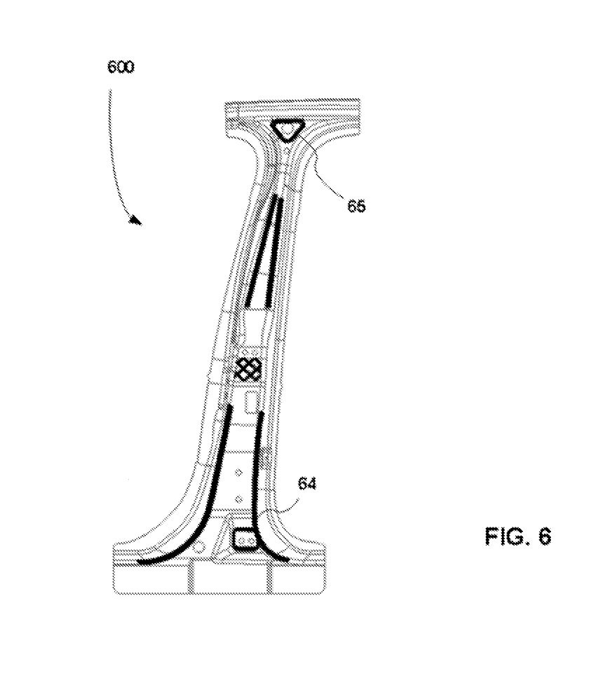

FIGS. 5A-5D show different examples of specific reinforcement geometries that may be obtained with methods substantially as hereinbefore described. As mentioned above, using a laser to melt a reinforcement material (powder or solid wire) may allow the formation of almost any desired geometry having e.g. different curvature, different size (length, width and height) or even crossing lines defining a grid. These methods are quite versatile. No extra material in a zone that does not need reinforcement is provided, and the final weight of the component may thus be optimized.

For example, FIGS. 5A and 5C show different discrete known shapes such as rectangles, squares, annular rings, half a ring and a cross among other possibilities. FIG. 5B shows curved lines defining each a substantially sinusoidal form and FIG. 5D shows straight lines crossing each other to define a grid.

It has been found that local reinforcements having a minimum thickness of 0.2 mm lead to good results while optimizing the weight of the final reinforced component. The minimum thickness may be obtained with e.g. only one material (e.g. powder or wire) deposition. Furthermore, each laser exposure and material deposition may involve a maximum thickness of approximate 1 mm. In some examples, the local reinforcement may have a thickness between approximately 0.2 mm and approximately 6 mm. This may be achieved with repetitive depositions of material or by slowing down the process.

And in more examples, the local reinforcement may have a thickness between approximately 0.2 mm and approximately 2 mm. In all these examples, the width of the local reinforcement with each material deposition and laser exposure may generally be between approximately 1 mm to approximately 10 mm.

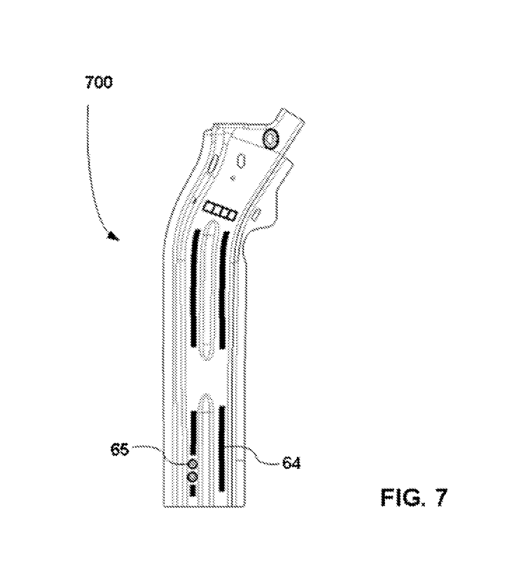

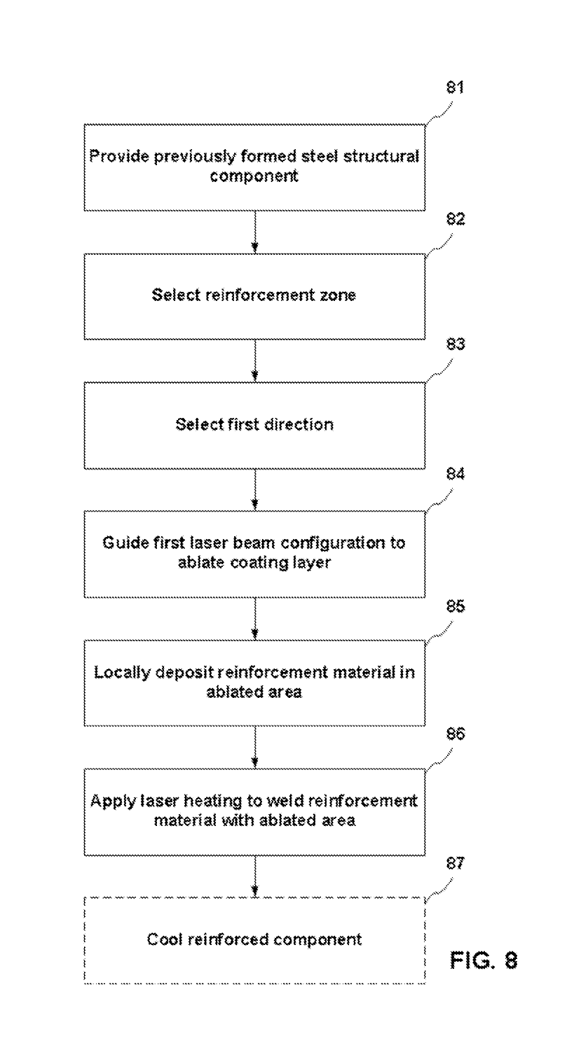

FIGS. 6 and 7 show different reinforced components obtained by any method substantially as herein described. In the example of FIG. 6 a B pillar 8 is schematically illustrated. In the example of FIG. 7 a bar 9 e.g. a cross/side member is schematically illustrated. Both components 8 and 9 may be formed e.g. by HFDQ process. In alternative examples, other ways of forming the component may also be foreseen such as cold forming, hydroforming or roll forming. Reinforcements 64 and 65 may be added by ablating the coating layer and depositing a reinforcement material while applying the second laser beam to melt the reinforcement material. Reinforcements 64 and 65 are designed e.g. to direct tensions and increase stiffness (rigidity) of the component. E.g. reinforcements 64 may be applied in order to improve strength in case of an impact in areas such as corners, end portions and reinforcements 65 may be applied in order to add strength to the component due to e.g. a hole made during manufacture so that the whole strength of the component is not affected by the presence of the hole. In general in a component, reinforcements may be required in those areas that need to withstand most loads, e.g. in a B pillar these areas are the corners.

FIG. 8 is a flow diagram of a method of manufacturing reinforced steel structural components according to an example. In a first block 81, a previously formed steel structural component is provided. The previously formed steel structural component may have a coating layer of e.g. aluminum or of an aluminum alloy. In block 82, a reinforcement zone of the previously formed steel structural component may be selected. In block 83, a first direction in the reinforcement zone may be selected. Then, in block 84, a first laser beam may be guided along the first direction to ablate a part of the coating layer of the reinforcement zone. In block 85, a material may be locally deposited on the ablated reinforcement zone to create a local reinforcement on a first side of the structural component. In block 86, laser heating may be substantially simultaneously applied along the first direction using a second laser beam to melt the reinforcement (metal filler) material and create the reinforcement. The first and the second laser beam may be moved in unison. In block 87, the reinforced component may be cooled or allowed to cool to so that the reinforcement material may adhere to the ablated steel substrate.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. Method for manufacturing reinforced steel structural components, the method comprising:
providing a previously formed steel structural component having a steel substrate and a metal coating layer,
selecting a reinforcement zone of the previously formed steel structural component,
selecting a first direction in the reinforcement zone;
guiding a first laser beam along the first direction to ablate a part of the coating layer of the reinforcement zone;
locally depositing a material on the ablated reinforcement zone to create a local reinforcement on a first side of the structural component, wherein locally depositing a material on the reinforcement zone comprises supplying a reinforcement material to the ablated reinforcement zone, and substantially simultaneously applying laser heating along the first direction using a second laser beam in unison with the first laser beam to melt the reinforcement material and part of the steel substrate of the ablated reinforcement zone to mix the melted reinforcement material with the melted part of the steel substrate.

2. Method according to claim 1, wherein the first laser beam comprises a single spot laser beam.

3. Method according to claim 1, wherein the first laser beam and/or the second laser beam comprises a twin spot laser beam, wherein the two spots are arranged substantially perpendicularly to the first direction.

4. Method according to claim 3, wherein the two spots are distributed evenly in the reinforcement zone.

5. Method according to claim 1, wherein the reinforcement material comprises a metal powder provided in a powder gas flow.

6. Method according to claim 1, wherein the reinforcement material comprises a solid metal provided as a metal wire.

7. Method according to claim 1, further comprising drawing specific geometric shapes on the first side of the structural component with the reinforcement material and the laser heating.

8. Method according to claim 1, further comprising providing cooling to areas on a second side of the structural component that is opposite to the first side.

9. Method according to claim 1, wherein the metal coating layer is a layer of aluminum or of an aluminum alloy or of zinc or of a zinc alloy.

10. Method according to claim 1, wherein the steel substrate is made from boron steel.

11. Method according to claim 1, wherein the previously formed structural component is obtained by hot forming die quenching.

12. Tool for reinforcing previously formed steel structural components, comprising:
an imaging device to select a reinforcement zone of a previously formed structural component having a metal coating, a laser head configuration, comprising:
a laser beam source to generate a first laser beam and a second laser beam;
the laser head configuration configured to direct the spot of the second laser beam at a distance of between 2mm and 50mm from the spot of the first laser beam;
a reinforcement material depositor;
a controller, coupled to the imaging device, the laser head configuration and the reinforcement material depositor, configured to
select a first direction based on data received from the imaging device;
guide the first laser beam along the first direction to ablate a part of the metal coating of the reinforcement zone;
instruct the reinforcement material depositor to locally deposit a metal filler material on the ablated reinforcement zone;
guide the second laser beam along the first direction in unison with the first laser beam to apply laser heating to melt the metal filler material and create the reinforcement.

13. Tool according to claim 12, wherein the laser beam source comprises a first laser source to generate a first laser beam and a second laser source to generate a second laser beam, wherein the first and second laser sources are comprised in a single laser head.

14. Tool according to claim 12, wherein the laser beam source comprises a first laser source to generate a first laser beam and a second laser source to generate a second laser beam, wherein the first laser source is comprised in a first laser head and the second laser source in a second laser head, the first and second laser heads arranged to be moveable in unison.

15. A product as obtainable by a method according to claim 1.
